(19) United States
(12) Patent Application Publication
(10) Pub. No.: US 2020/0189105 A1
(43) Pub. Date: Jun. 18, 2020

(54) TASK-SPECIFIC ROBOT GRASPING SYSTEM AND METHOD

(71) Applicant: Siemens Aktiengesellschaft, München (DE)

(72) Inventors: Chengtao Wen, Redwood City, CA (US); Juan L. Aparicio Ojea, Moraga, CA (US); Eugen Solowjow, Berkeley, CA (US); Martin Sehr, Kensington, CA (US); Heiko Claussen, North Brunswick, NJ (US)

(21) Appl. No.: 16/710,063

(22) Filed: Dec. 11, 2019

(30) Foreign Application Priority Data
Dec. 18, 2018 (EP) 18213367.8

(51) Int. Cl. B25J 9/16

(52) U.S. Cl. CPC B25J 9/1669; B25J 9/1687; B25J 9/1697; B25J 9/161

(57) ABSTRACT

A robot operable within a 3-D volume includes a gripper movable between an open position and a closed position to grasp any one of a plurality of objects, an articulatable portion coupled to the gripper and operable to move the gripper to a desired position within the 3-D volume, and an object detection system operable to capture information indicative of the shape of a first object of the plurality of objects positioned to be grasped by the gripper. A computer is coupled to the object detection system. The computer is operable to identify a plurality of possible grasp locations on the first object and to generate a numerical parameter indicative of the desirability of each grasp location, wherein the numerical parameter is at least partially defined by the next task to be performed by the robot.

### TECHNICAL FIELD

The present disclosure is directed, in general, to a system and method for automatically selecting the optimum grasping position of an object by a robot, and more specifically to such a system that uses upcoming activities as a parameter in selecting the grasping position.

### BACKGROUND

Automation of tasks such as assembly, warehouse stocking, packaging, and the like are being increasingly performed by robots. Robots have proven effective at performing repetitive tasks with little or no user intervention. However, as the tasks performed by the robots become increasingly diverse, additional programming of the robots becomes necessary to assure proper operation. The additional programming can become overly-burdensome and complex in situations where each object handled by the robot is randomly delivered from a number of options or where the task to be performed with each object can differ.

### SUMMARY

A robot operable within a 3-D volume includes a gripper movable between an open position and a closed position to grasp any one of a plurality of objects, an articulatable portion coupled to the gripper and operable to move the gripper to a desired position within the 3-D volume, and an object detection system operable to capture information indicative of the shape of a first object of the plurality of objects positioned to be grasped by the gripper. A computer is coupled to the object detection system. The computer is operable to identify a plurality of possible grasp locations on the first object and to generate a numerical parameter indicative of the desirability of each grasp location, wherein the numerical parameter is at least partially defined by the next task to be performed by the robot.

In another construction, a robot operable within a 3-D volume includes a gripper movable between an open position and a closed position to grasp any one of a plurality of objects, an articulatable portion coupled to the gripper and operable to move the gripper to a desired position within the 3-D volume, and an imaging system operable to capture an image of a first object of the plurality of objects which is positioned to be grasped by the gripper. A computer is coupled to the imaging system and includes a neural network that identifies a plurality of possible grasp locations on the first object, and that determines a numerical parameter of the desirability of each grasp location, wherein the numerical parameter is at least partially defined by the next task to be performed by the robot, and the arrangement of the gripper, and wherein a portion of the plurality of possible grasp locations are eliminated at least partially in response to an available movement path of the gripper and the articulatable portion within the 3-D volume.

In another construction, a method of gripping an object with a robot that is movable within a 3-D volume includes connecting a gripper that is movable between an open position and a closed position to an articulatable portion of the robot, capturing an image of the object to be grasped, and operating a neural network on a computer to analyze the image and generate a plurality of possible grasp locations for consideration. The method also includes assigning a numerical parameter indicative of the desirability of each grasp location to each grasp location, wherein the numerical parameter is at least partially defined by the next task to be performed by the robot, selecting the most desirable grasp location based on the numerical parameter, and grasping the object in the selected grasp location.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this specification and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 is a schematic illustration of a robot grasping system.

FIG. 2 is a perspective view of a possible item to be grasped.

FIG. 3 is a gripper from the robot of FIG. 1 grasping the item of FIG. 2 in one possible grasp location.

FIG. 4 is the gripper from the robot of FIG. 1 grasping the item of FIG. 2 in another possible grasp location.

FIG. 5 is a schematic flow chart illustrating the operation of the gripping system.

FIG. 6 is a flow chart illustrating a method of selecting a grasp location.

FIG. 7 is a perspective view illustrating the placement of an object in a partially filled volume.

FIG. 8 is a perspective view illustrating the placement of the object of FIG. 7 into the same volume as illustrated in FIG. 7 but partially filled in a different manner.

FIG. 9 is a perspective view illustrating the placement of the object of FIG. 7 into the same volume as illustrated in FIG. 7 but partially filled in a different manner.

FIG. 10 is a perspective view of an assembled gear arrangement.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard as available a variation of twenty percent would fall within the meaning of these terms unless otherwise stated.

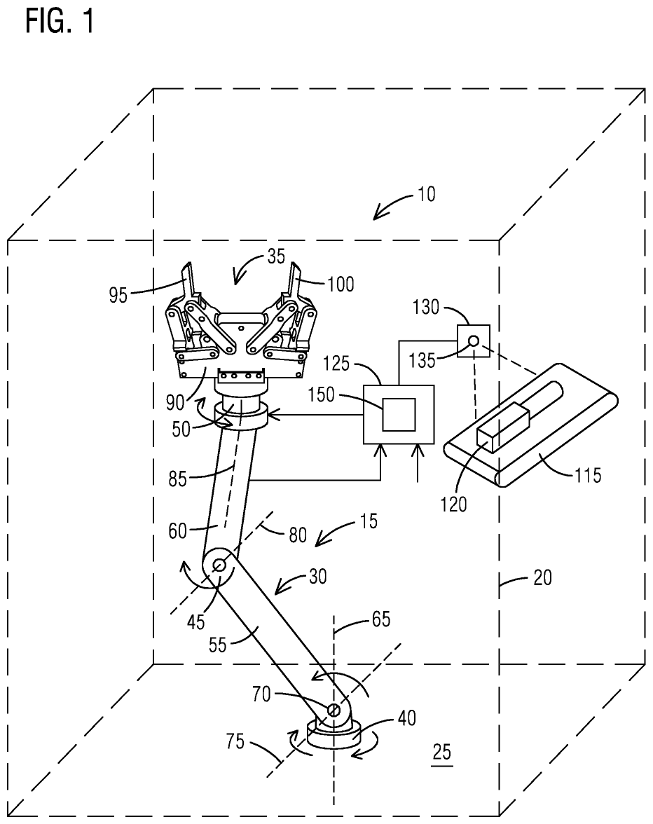

FIG. 1 schematically illustrates an automated system 10 that includes a robot 15 that is movable within a 3-D volume 20 or operating envelope. The robot 15 in FIG. 1 is fixedly attached to a floor 25 or base and includes an articulatable portion 30 and a gripper 35 attached to the articulatable portion 30. The articulatable portion 30 includes a shoulder joint 40, an elbow joint 45, a wrist joint 50, a first arm 55 extending between the shoulder joint 40 and the elbow joint 45, and a second arm 60 extending between the elbow joint 45 and the wrist joint 50. The shoulder joint 40 provides for rotation of the first arm 55 around a first axis 65 that extends vertically through the shoulder join 40t. The shoulder joint 40 also includes a pivot joint 70 that allows the first arm 55 to pivot about a second axis 75 that is normal to the first axis 65 and that passes through the pivot point. The elbow joint 45 includes a pivot point that allows for pivoting motion of the second arm 60 with respect to the first arm 55 about a third axis 80 that is normal to the first axis 65. The third axis 80 can be oriented at any desired angle with respect to the second axis 75 to provide the desired range of motion at the elbow joint 45. The wrist joint 50 connects the second arm 60 to the gripper 35 and provides for relative rotation between the gripper 35 and the second arm 60 about a fourth axis 85 that extends along the length of the second arm 60. The elbow joint 45 can also include a pivot joint to allow the gripper 35 to pivot with respect to the second arm 60.

The gripper 35 includes a body 90 that connects to the wrist joint 50, a first finger 95 and a second finger 100. The first finger 95 and the second finger 100 each include an engagement surface 105 arranged to grasp various objects. The first finger 95 and the second finger 100 attach to the body 90 and are movable between an open position in which the engagement surfaces 105 of the first finger 95 and the second finger 100 are spaced apart from one another and a closed position in which the engagement surfaces 105 of the first finger 95 and the second finger 100 are either in contact with one another or spaced very close to one another. In the illustrated construction, two linkages 110 interconnect the first finger 95 and the second finger 100 to the body 90. The linkages 110 are arranged to assure that the engagement surfaces 105 remain substantially parallel to one another while in any position between the open position and the closed position.

As one of ordinary skill will realize, there is great variation in the design of the gripper 35 available in the robot arts. Grippers could include fingers 95, 100 that move linearly on a screw mechanism or could include fingers 95, 100 that pivot and do not remain parallel. Entirely different gripper mechanisms such as vacuum systems, magnetic systems, three or more finger systems, etc. could also be employed. In addition, many different arrangements are available for the articulatable portion including linear motion robots, fewer joints or more joints, etc. The actual design of the articulatable portion 30 and the gripper 35 are not critical to the invention so long as the articulatable portion 30 is able to move the gripper 35 into desired locations and orientations and the gripper 35 is able to grip multiple different objects in different ways.

As discussed, the robot 15, and specifically the articulatable portion 30 and the gripper 35 are movable to any point within the predefined 3-D volume 20 to pick up an object or perform a particular task. Each robot 15 has a predefined limit of motion that is well-known and is a function of the construction of the robot 15.

With continued reference to FIG. 1, a conveyor system 115 is shown conveying an object 120 into the 3-D volume 20 of the robot 15. The robot 15 is positioned to grasp the object 120 and then perform a secondary task with the object 120. The secondary task could be to package the object 120 for shipping, place the object 120 in a machine tool or into storage, perform an assembly task such as attaching the object 120 to another component or part, and the like. Virtually any secondary task could be accommodated. While the conveyor system 115 is illustrated in FIG. 1, the object 120 could be delivered to the robot 15 using any available system or arrangement.

A computer 125 is connected to the robot 15 to control the movement of the robot 15. The computer 125 receives feedback from various sensors on the robot 15 and in the related systems and generates control signals to move the articulatable portion 30 and the gripper 35 as required for a particular operation. The computer 125 also receives user input such as manufacturing plans, customer orders, and the like such that the computer 125 includes the next step for any given object 120 that is delivered on the conveyor system 115.

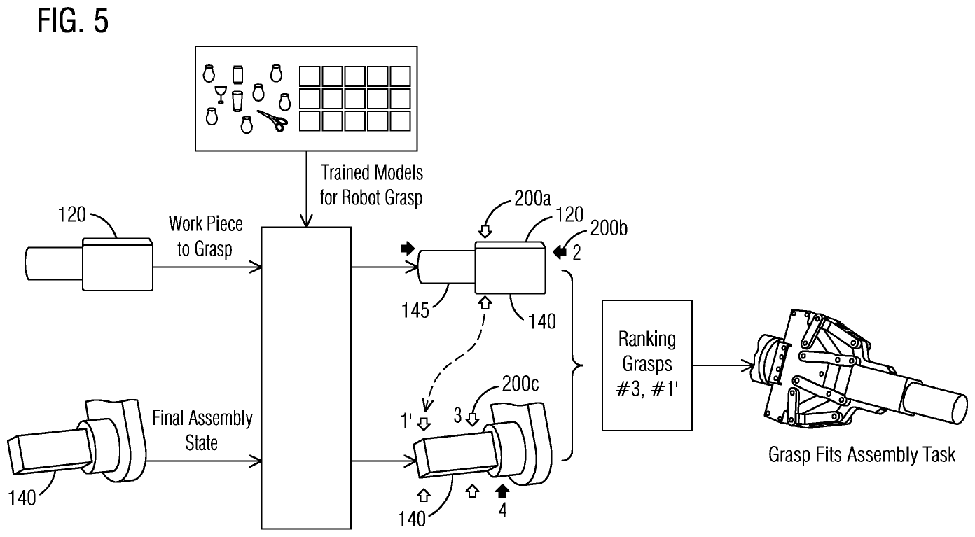

An object detection system 130 is also connected to the computer 125 and positioned to detect objects 120 on the conveyor 115 and within the 3-D volume 20. The object detection system 130 detects more than the presence of the object 120. Rather, the object detection system 130 detects what the object 120 is. In one construction, the object detection system 130 includes an imaging system 135 that captures a still image of the object 120. The still image is sent to the computer 125 and the computer 125 analyzes the image to determine what object 120 is in position to be grasped. In other constructions, other detection systems 130 may be employed. For example, one system 130 could read an RFID, bar code, or other indicator attached to or proximate the object 120 and send that information to the computer 125 to identify the object 120. For object detection systems 130 that do not capture an image of the object 120, images would need to be available to the computer 125 for each possible object 120. The images would be associated with the object 120 and used to determine grasp locations as will be discussed with regard to FIG. 5.

The software aspects of the present invention could be stored on virtually any computer readable medium including a local disk drive system, a remote server, internet, or cloud-based storage location. In addition, aspects could be stored on portable devices or memory devices as may be required. The computer 125 generally includes an input/output device that allows for access to the software regardless of where it is stored, one or more processors, memory devices, user input devices, and output devices such as monitors, printers, and the like.

The processor could include a standard micro-processor or could include artificial intelligence accelerators or processors that are specifically designed to perform artificial intelligence applications such as artificial neural networks, machine vision, and machine learning. Typical applications include algorithms for robotics, internet of things, and other data-intensive or sensor-driven tasks. Often AI accelerators are multi-core designs and generally focus on low-precision arithmetic, novel dataflow architectures, or in-memory computing capability. In still other applications, the processor may include a graphics processing unit (GPU) designed for the manipulation of images and the calculation of local image properties. The mathematical basis of neural networks and image manipulation are similar, leading GPUs to become increasingly used for machine learning tasks. Of course, other processors or arrangements could be employed if desired. Other options include but are not limited to field-programmable gate arrays (FPGA), application-specific integrated circuits (ASIC), and the like.

The computer 125 also includes communication devices that may allow for communication between other computers or computer networks, as well as for communication with other devices such as machine tools, work stations, actuators, controllers, sensors, and the like.

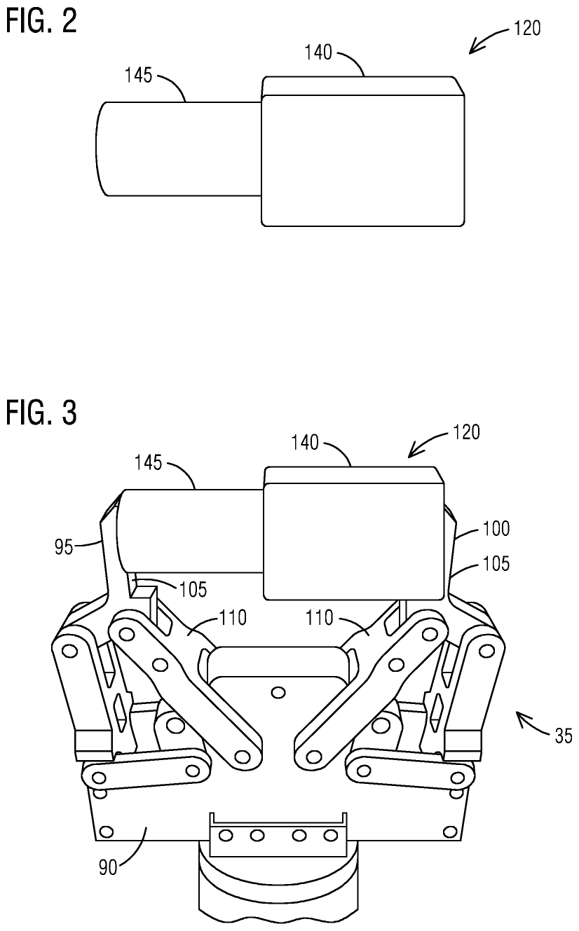

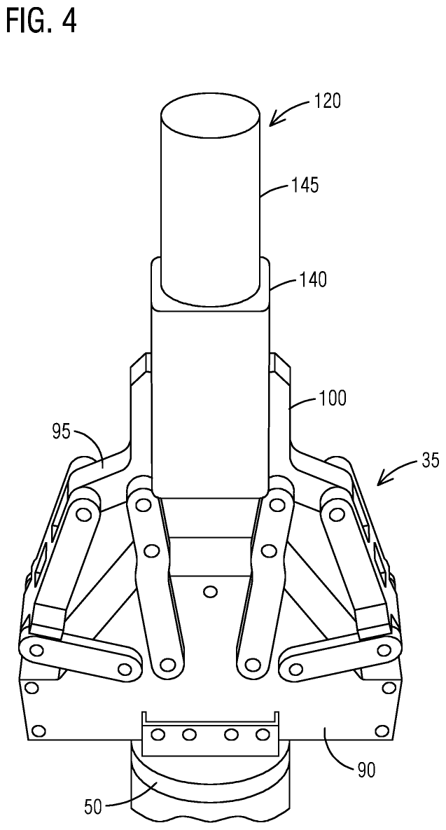

FIG. 2 illustrates an example of an object 120, part, or component, to be grasped. The object 120 includes a first portion 140 having a rectangular cross section that extends along a length. A second portion 145 extends from an end of the first portion 140 and has a circular cross section. The object 120 of FIG. 2 can be grasped in a number of different ways by the robot 15 of FIG. 1. FIG. 3 illustrates one possible grasp arrangement in which the gripper 35 is positioned near the open position and the first finger 95 and second finger 100 engage the exposed ends of the first portion 140 and the second portion 145. FIG. 4 illustrates a second grasp arrangement in which the gripper 35 engages two parallel sides of the first portion 140. As one of ordinary skill will realize, there are many different ways to grasp the object 120 of FIG. 2.

In many applications, the robot 15 may be used to grasp the object 120 and then perform a task with that object 120. In repetitious tasks where the same object 120 is repeatedly grasped with the same task then being performed with the object 120, the robot 15 can simply be programmed to perform the grasp and task. However, more flexible systems are needed when any one of a large number of objects 120 may appear on the conveyor 115 and each object 120 may have a different task to be performed depending on the object 120. In systems like this, straightforward programming of the robot 15 may be prohibitive.

The computer 125 illustrated in FIG. 1 includes a neural network model 150 capable of deep learning that is used to determine how to grasp the object 120 identified by the object detection system 130. The neural network model 150 is trained using an existing database such as Dex-Net 2.0 provided by Berkeley Artificial Intelligence Research (BAIR) or other such databases to recognize different shapes and to determine different possible grasp locations.

Once trained, the computer 125 uses the captured image, or an otherwise obtained image of the object 120 to determine possible grasp locations, to estimate the quality of each grasp location, and to assign a numerical parameter indicative of that quality. For example, the computer 125 could assign a value between 0 and 100 with 100 being the best possible grasp location.

Thus, the system described herein determines optimal grasping locations without pre-programming of the computer 125. Possible grasp positions can be found on the edges of the object 120 to be grasped. The search for the optimal grasp location can be implemented by a genetic algorithm like a particle filter motivated approach. That is, grasp candidates are uniformly sampled on the edges, when a good grasp is found there is a high likelihood that other grasp candidates are generated with a gaussian distribution in its proximity. If a grasp candidate is bad, the candidate is forgotten and no “offsprings” are generated in its proximity. This process is continued to iteratively find the best grasp candidate or candidates.

As illustrated in FIG. 5, the trained neural network model 150 uses an image of the object 120 to be grasped to select a number of different candidate grasp locations. FIG. 5 illustrates three possible grasp locations labelled 200a, 200b, and 200c. To enhance production rates, data regarding the gripper 35 is also provided to the computer 125 and accounted for in the analysis of the candidate grasp locations. Any possible grasp locations that require the gripper 35 to move to a point that is not between the open position and the closed position are either weighted very low or preferably eliminated from consideration. Similarly, data regarding the particular robot 15 being used is provided to the computer 125 to define the 3-D volume 20 in which the robot 15 can work. This 3-D volume 20 could be further limited by specific limitations within a particular application. For example, one robot may be capable of moving over a walkway, but it may be undesirable to allow it to do so. In this case, the walkway can be omitted from the 3-D volume of the robot. Any possible grasp locations that require the robot 15 to move to a point that is outside of the 3-D volume 20 are either weighted very low or preferably eliminated from consideration.

The computer 125 is also provided with data regarding the next step to be performed with the particular object 120. In one construction, the computer 125 includes a database of next tasks that are each associated with a different potential object 120 to be grasped. The next task could be assembly related, could require the packaging of the object 120, could require the placement of the object 120 in a machine tool, or could include another task.

The next task acts as a further constraint that is analyzed by the computer 125 to adjust the numerical parameter. For example, FIG. 5 illustrates that the next step for the object 120 of FIG. 2 is an assembly step in which the second portion 145 is inserted into an aperture to attach the object 120 to another component. With this constraint, the grasping position illustrated in FIG. 3 receives a very low numerical parameter while the position illustrated in FIG. 4 receives a higher numerical parameter. FIG. 5 illustrates several possible grasping positions 200a, 200b, and 200c that can be used by the gripper 35 to grasp an object 120. FIG. 3 illustrates one possible grasping position 200b, with FIG. 4 illustrating a second grasping position 200c. Grasping position 200a is another grasping position in which the gripper 35 grasps the first portion 140 of the object 120 but is rotated ninety degrees with respect to the position illustrated in FIG. 4. More specifically, as illustrated in FIG. 4, the long axis of the object 120 extends away from the robot when using the gripping position 200c. However, 200a is meant to illustrate a grasping position in which the gripper 35 crosses the long axis of the object 120. This grasping position is similar in quality to the grasping position illustrated in FIG. 4. However, in this position, the gripper 35 can interfere with the assembly step. Thus, this gripping position is given a lower numeric parameter based on the constraint provided by the next step.

With the evaluation of candidate gripping positions complete, the computer 125 selects the most desirable gripping position and provides the necessary instructions to the robot 15 to grasp the object 120 as desired and perform the assembly step.

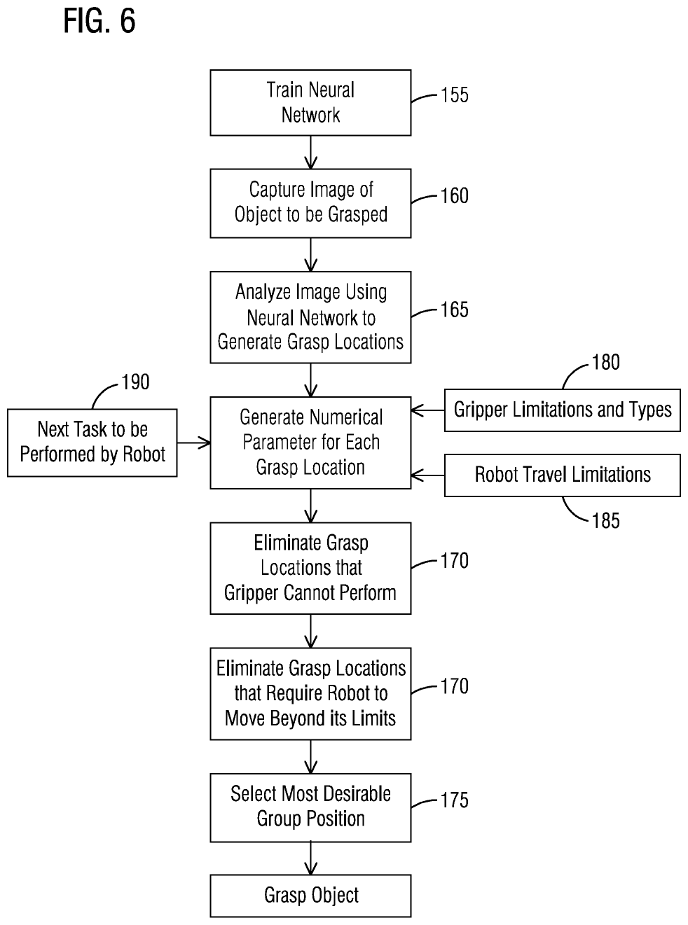

In use and as illustrated in FIG. 6, a user first trains (step 155) the neural network model 150 in the computer 125 to recognize different shapes and potential grasping positions. Next, an image of an object to be grasped is generated or accessed (step 160). In systems 10 that image the object 120 to determine what the object 120 is, that image can be used. In systems 10 that determine what the object 120 is in another way, a database of images is needed to provide the necessary image to the neural network model 150 so that it can apply what it has previously learned to determine how to grasp the object. The computer 125 uses the neural network model 150 to analyze the image and generate potential grasping locations 165. The computer 125 uses information about the gripper 35 (block 180) and the robot (block 185) to generate a numerical parameter for each grasp location 191 and to eliminate grasping positions 170 that cannot be performed by either the gripper 35 or the articulating portion 30 of the robot 15. The next task to be performed by the robot 15 is either provided by a user or extracted from a database or other source based on the identification of the object 120 being grabbed (block 190). The next task is used to weight the numerical parameter such that gripping positions that don't facilitate the next step receive a lower numerical parameter than gripping positions that better facilitate the next step.

The numerical parameter is used to select the most desirable gripping position 175. The computer 125 provides the necessary commands to the robot 15 to cause the robot 15 to grab the object 120 using the selected gripping position and to perform the next task.

In yet another application, a robot is used to pack a bin or other storage space 210 having a fixed volume. When packing a bin or other volume, objects of different sizes, shapes, or volumes must be packed into a finite number of bins or containers, so as to minimize the number of bins used or maximize the number of objects packed in the volume. A variant of bin packing that occurs in practice is when the packing is constrained by size, by weight, by cost, etc. Bin or volume packing is important in industrial and commercial applications, in logistics, supply chain management and manufacturing, such as loading trucks with weight capacity constraints, filling containers, storing goods in warehouses, and cutting raw materials. Robotic bin packing requires industrial robots to implement an optimized bin packing strategy, i.e. grasping and packing the objects in the desired poses (e.g. locations and orientations).

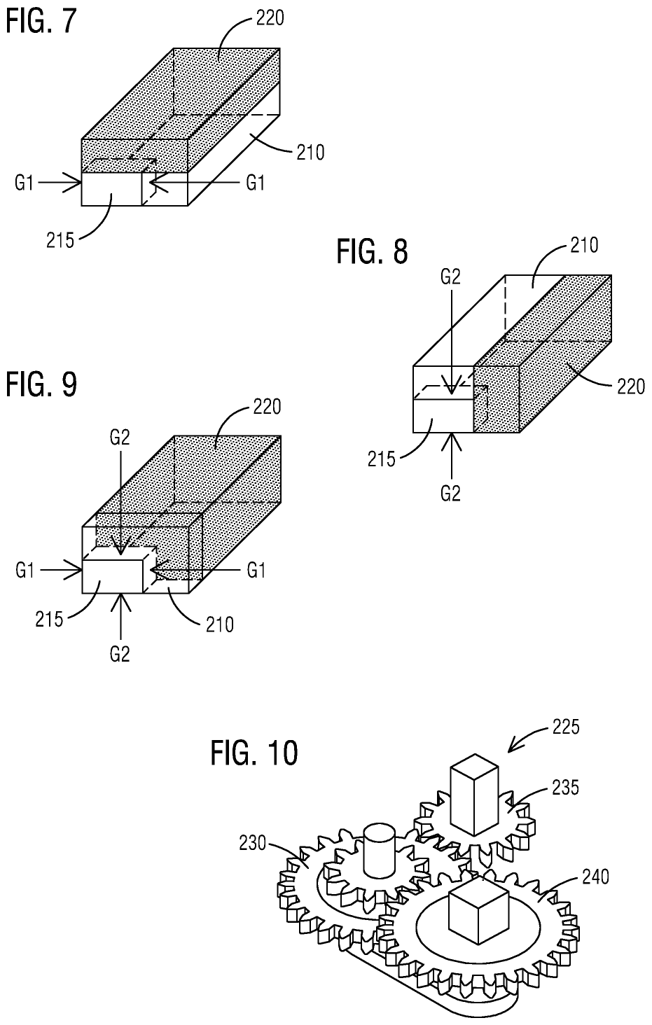

Task-specific grasping will significantly boost the efficiency of robotic bin packing. In order to implement the optimal bin packing strategy, each grasping and packaging operation is dependent on the previous operation or operations as well as subsequent operations. Therefore, the proposed method may calculate different but more efficient task-relevant grasping points for the same object depending on the available storage geometry or space. Thus, the same object may be grasped one way to place a first object in a bin and a second way to place a second object in the bin. FIGS. 7-9 illustrates a simple example of a bin packing problem in which a cube-shaped object 215 is being packed into a partially filled or otherwise restricted volume 210. In FIG. 7, the top half of the volume is filled 220 or otherwise blocked such that the object 215 must be placed beneath this blocked space 220. For this case, the best grasping locations are illustrated with arrows G1. In FIG. 8, the same object 215 is being placed in the same volume 210 with the right half of the volume 220 being blocked or otherwise occupied. In this situation, the grasping location of FIG. 7 (G1) is not suitable and instead, a second grasping location illustrated with arrows G2 in FIG. 8 is used. FIG. 9 illustrates a third situation in which the back portion of the volume 220 is occupied or otherwise blocked, thereby leaving room for the object 215 in the front of the volume 210. In this case, the object 215 could be grasped using either the grasp location of FIG. 7 (G1) or the grasp location of FIG. 8 (G2). Other constraints or limitations would be used to ultimately determine which of the possibilities should be employed.

Future manufacturing will move towards higher level of automation, e.g. mass customization require manufacturing in small production volumes and with high product variability. Future manufacturing automation systems will need the ability to adapt to changing complex environments. In many autonomous manufacturing tasks, grasping and assembling operations are dependent on the sequence of manufacturing operations, which are task relevant.

FIG. 10 illustrates a gear assembly 225 in which the robot must grasp and assemble the set of gears with different sizes and geometries on the gear holders of different shapes. The first gear 230 to be assembled is a double-layered gear on a round holder. The teeth of a second gear 235 and a third gear 240 must match those of the adjoining gear 230 or other gears. Task-specific grasping points are needed to perform the gear assembly task. This implies that both gear geometry and final assembled position will be used to generate candidate grasp locations.

Task-specific grasping can also be used to automatically select between different types of grippers. Traditional grippers can be categorized as magnetic, vacuum, mechanical collet-type, and mechanical gripper-type. Magnetic grippers are typically used for lifting and moving ferromagnetic pieces such as steel sheets, blanks, and stamped parts. Vacuum (suction) grippers can be used for grasping non-ferrous objects where a magnetic gripper might otherwise be suitable. Multi-finger mechanical grippers are the most popular mechanical grippers. Two-finger grippers can grasp and handle a wide range of objects with good precision as illustrated in FIGS. 1-6, but they can be of low efficiency when changing part size or geometry. Three-fingered grippers can be more precise and can handle more diverse part sizes and shapes, but they are generally more expensive and complicated.

When multiple grippers are available, the system described herein can evaluate the different possible grasps for each possible gripper to determine the most efficient way to grasp an object and perform a subsequent step or steps with that object. For a given task and object, the system first evaluates all possible grasping locations for all available grippers. The system selects the best grasping location and thereby, the best gripper for the task. In another arrangement, the system first selects the most desirable gripper. The system then calculates a set of potential grasping locations using the selected gripper.

As an example, the gear assembly 225 of FIG. 10 can be assembled using multiple different grippers. A three-finger gripper can be used to assemble the first gear 230 (double-layered on round holder). Next, a vacuum gripper could be used to assemble the smallest gear 235 (with a single small square hole in the center).

The system described herein improves the art of robotics and more specifically the use of robots in grasping applications. By accounting for the upcoming tasks in making grasping decisions, the efficiency of the complete assembly process can be improved.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A robot operable within a 3-D volume, the robot comprising:
a gripper movable between an open position and a closed position to grasp any one of a plurality of objects;
an articulatable portion coupled to the gripper and operable to move the gripper to a desired position within the 3-D volume;
an object detection system operable to capture information indicative of the shape of a first object of the plurality of objects positioned to be grasped by the gripper; and
a computer coupled to the object detection system, the computer operable to identify a plurality of possible grasp locations on the first object and to generate a numerical parameter indicative of the desirability of each grasp location, wherein the numerical parameter is at least partially defined by the next task to be performed by the robot.

2. The robot of claim 1, wherein the object detection system includes an imaging system that captures an image of the first object.

3. The robot of claim 2, wherein the computer includes a neural network that identifies a plurality of possible grasp locations on the first object, wherein the numerical parameter is at least partially defined by the arrangement of the gripper, and wherein a portion of the plurality of possible grasp locations are eliminated at least partially in response to an available movement path of the gripper and the articulatable portion within the 3-D volume.

4. The robot of claim 1, wherein the computer includes a processor and a neural network operable to identify the plurality of possible grasp locations.

5. The robot of claim 1, wherein the numerical parameter is at least partially defined by the arrangement of the gripper.

6. The robot of claim 1, wherein the computer eliminates any possible grasp locations that require the gripper to move to a position that is not between the open position and the closed position.

7. The robot of claim 1, wherein the numerical parameter is at least partially defined by an available movement path of the gripper and the articulatable portion within the 3-D volume.

8. The robot of claim 1, wherein the computer eliminates any possible grasp locations that require movement of the gripper or the articulatable portion along a path that is not within the 3-D volume.

9. The robot of claim 1, wherein the computer identifies the plurality of possible grasp locations on the first object without pre-programming.

10. The robot of claim 1, wherein the next task is an assembly task in which the first part is attached to another component.

11. A method of gripping an object with a robot that is movable within a 3-D volume, the method comprising:
connecting a gripper that is movable between an open position and a closed position to an articulatable portion of the robot;
capturing an image of the object to be grasped;
operating a neural network on a computer to analyze the image and generate a plurality of possible grasp locations for consideration;
assigning a numerical parameter indicative of the desirability of each grasp location to each grasp location, wherein the numerical parameter is at least partially defined by the next task to be performed by the robot;
selecting the most desirable grasp location based on the numerical parameter; and grasping the object in the selected grasp location.

12. The robot of claim 11, wherein the numerical parameter is at least partially defined by the arrangement of the gripper.

13. The robot of claim 11, further comprising eliminating from consideration any possible grasp locations that require the gripper to move to a position that is not between the open position and the closed position.

14. The robot of claim 11, wherein the numerical parameter is at least partially defined by an available movement path of the gripper and the articulatable portion within the 3-D volume.

15. The method of claim 11, further comprising eliminating from consideration any possible grasp locations that require movement of the gripper or the articulatable portion outside of the 3-D volume.

16. The robot of claim 11, wherein the computer identifies the plurality of possible grasp locations on the first object without pre-programming.

17. The robot of claim 11, wherein the next task is an assembly task in which the first part is attached to another component.
